(19) United States
(12) Patent Application Publication
(10) Pub. No.: US 2026/0175871 A1
(43) Pub. Date: Jun. 25, 2026

(54) VEHICLE CONTROL DEVICE AND STORAGE MEDIUM

(71) Applicants: TOYOTA JIDOSHA KABUSHIKI KAISHA, Toyota-shi, (JP); ADVICS CO., LTD., Kariya-shi (JP)

(72) Inventors: Kazuki MIYAKE, Okazaki-shi (JP); Wataru KANDA, Nisshin-shi (JP); Mitsuhiro TSUMANO, Higashiosaka-shi (JP); Taisuke HAYASHI, Toyota-shi (JP); Masayuki ASANO, Tokyo (JP); Michihiro OHTSUBO, Tokyo (JP); Takaya UCHIDA, Tokyo (JP)

(73) Assignees: TOYOTA JIDOSHA KABUSHIKI KAISHA, Toyota-shi (JP); ADVICS CO., LTD., Kariya-shi (JP)

(21) Appl. No.: 19/412,145

(22) Filed: Dec. 8, 2025

(30) Foreign Application Priority Data
Dec. 19, 2024 (JP) 2024-224425

(51) Int. Cl. B60W 60/00

(52) U.S. Cl. CPC B60W 60/001; B60W 2710/18

(57) ABSTRACT

A vehicle control device includes a control unit configured to: when a vehicle is decelerating, calculate a stop determination timing for the vehicle to stop based on a detection value related to traveling of the vehicle, and set a first stop flag from an OFF state to an ON state at the stop determination timing; when determination is made that the vehicle has stop intention based on the detection value, set a second stop flag from an OFF state to an ON state; when the first stop flag is in the ON state and the second stop flag is in the ON state, execute stop keeping pre-control for keeping the vehicle in a stopped state; and when the first stop flag is in the ON state and the second stop flag is in the OFF state, not execute the stop keeping pre-control.

### CROSS-REFERENCE TO RELATED APPLICATION

This application claims priority to Japanese Patent Application No. 2024-224425 filed on Dec. 19, 2024. The disclosure of the above-identified application, including the specification, drawings, and claims, is incorporated by reference herein in its entirety.

### BACKGROUND

### 1. Technical Field

The present disclosure relates to a vehicle control device and a storage medium storing a computer program for executing braking control.

### 2. Description of Related Art

Japanese Unexamined Patent Application Publication No. 2021-123139 (JP 2021-123139 A) proposes a technology that can appropriately keep a stopped state of a vehicle when the vehicle traveling by autonomous driving decelerates and stops. The technology described in JP 2021-123139 A is configured to control deceleration based on a command to decelerate the vehicle when stopping the vehicle, and stop the vehicle based on a stop command to keep the vehicle in a stopped state when the vehicle speed is equal to or lower than a predetermined speed.

### SUMMARY

Under a predetermined condition such as traffic congestion, a vehicle may repeatedly decelerate and accelerate at extremely low speeds. When the vehicle is traveling at extremely low speeds under the predetermined condition based on the technology described in JP 2021-123139 A, control is executed to keep the vehicle in a stopped state based on the stop command, which may result in an unnecessary braking shock to the vehicle.

The present disclosure has an object to provide a vehicle control device and a storage medium storing a computer program that can reduce a braking shock caused by a braking force that is not requested by a system during autonomous driving.

One aspect of the present disclosure is a vehicle control device including a control unit configured to execute stop control on a vehicle traveling by autonomous driving. The control unit is configured to: when the vehicle is decelerating, calculate a stop determination timing for the vehicle to stop based on a detection value related to traveling of the vehicle, and set a first stop flag from an OFF state to an ON state at the stop determination timing; when determination is made that the vehicle has stop intention based on the detection value, set a second stop flag from an OFF state to an ON state; when the first stop flag is in the ON state and the second stop flag is in the ON state, execute stop keeping pre-control for keeping the vehicle in a stopped state; and when the first stop flag is in the ON state and the second stop flag is in the OFF state, not execute the stop keeping pre-control.

According to the present disclosure, it is possible to reduce the braking shock caused by the braking force that is not requested by the system during the autonomous driving.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing the configuration of a vehicle control device according to an embodiment;

FIG. 2 is a diagram showing an example of a process for stop keeping pre-control;

FIG. 3 is a diagram showing an example of the process for the stop keeping pre-control;

FIG. 4 is a diagram showing an example of the process for the stop keeping pre-control;

FIG. 5 is a diagram showing an example of a process for stop keeping pre-control based on a related-art method; and

FIG. 6 is a flowchart showing the flow of a process in a vehicle control method to be executed by the vehicle control device.

### DETAILED DESCRIPTION OF EMBODIMENTS

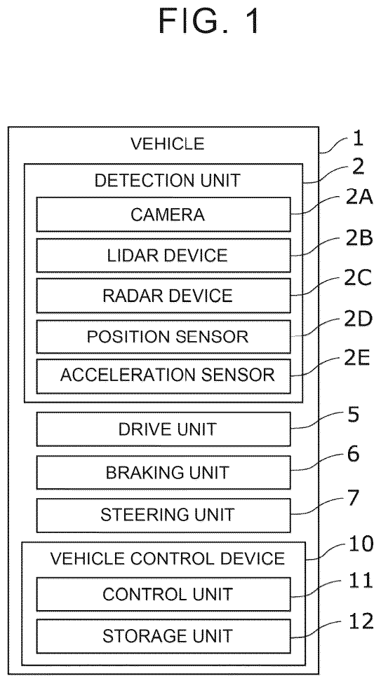

As shown in FIG. 1, a vehicle 1 includes a detection unit 2 and a vehicle control device 10 to execute autonomous driving. The detection unit 2 detects an environment around the vehicle 1. The detection unit 2 includes a plurality of devices depending on applications. Detection values detected by the detection unit 2 are used to execute autonomous driving.

The detection unit 2 includes a camera 2A that captures an image of the environment around the vehicle 1. The camera 2A captures an image of the surroundings of the vehicle 1 and outputs captured image data. In the present embodiment, the camera 2A captures an image of a predetermined range around the vehicle 1. The captured image data obtained by the camera 2A is used, for example, for autonomous driving of the vehicle 1 or for a driving recorder. The imaging range and imaging direction of the camera 2A may differ depending on the vehicle 1.

The detection unit 2 includes a lidar device 2B that detects three-dimensional data around the vehicle 1. The lidar device 2B radiates laser light ahead of the vehicle 1 or around the vehicle 1 in a detection region every predetermined period, and measures the light reflected from objects. The lidar device 2B is configured to adjust the detection region. The lidar device 2B scans the detection region with laser light and acquires measurement data. The lidar device 2B is configured to generate three-dimensional point cloud data of the surroundings of the vehicle 1 based on the measurement data.

The measurement values obtained by the lidar device 2B are used to detect other vehicles, pedestrians, bicycles, motorbikes, and other traffic participants present around the vehicle 1, as well as objects present around the vehicle 1. The lidar device 2B detects road structures present in a road environment.

The detection unit 2 includes, for example, a radar device 2C that detects objects present around the vehicle 1 by scanning with radar waves. The radar device 2C is configured to complement the lidar device 2B in detecting objects. The radar device 2C radiates millimeter radar waves to a detection region and receives the waves reflected from objects, thereby detecting relative distances to the objects. The radar device 2C is configured to adjust the detection region.

The measurement values obtained by the radar device 2C are used to detect other vehicles, pedestrians, bicycles, motorbikes, and other traffic participants present around the vehicle 1, as well as objects present around the vehicle 1. The radar device 2C detects road structures present in a road environment. The lidar device 2B and/or the radar device 2C constitute an object recognition unit.

The detection unit 2 includes a position sensor 2D that detects a current position of the vehicle 1. The position sensor 2D is, for example, a global positioning system (GPS) sensor or a global navigation satellite system (GNSS) sensor. Sensors to be used for autonomous navigation, such as a gyro sensor and an acceleration sensor 2E, may complement the position sensor 2D for the position of the vehicle 1.

The detection unit 2 includes the acceleration sensor 2E that detects an acceleration occurring in the vehicle 1. The acceleration sensor 2E includes, for example, sensors that detect accelerations occurring in the vehicle 1 in six axial directions. The detection values detected by the acceleration sensor 2E are used to calculate the acceleration and speed of the vehicle 1.

The vehicle 1 includes a drive unit 5 that generates power for traveling. The drive unit 5 is, for example, an internal combustion engine that uses fuel. When the vehicle 1 is an electrified vehicle, the drive unit 5 may be an electric motor. When the vehicle 1 is a hybrid electric vehicle, the drive unit 5 may be a combination of an internal combustion engine and an electric motor. During autonomous driving, the drive unit 5 is controlled by the vehicle control device 10 to adjust the speed.

The vehicle 1 includes a braking unit 6 that reduces the vehicle speed and controls the vehicle 1 in a stopped state. The braking unit 6 is, for example, a brake device that generates a braking force. When the vehicle 1 is an electrified vehicle, the braking unit 6 may be integrated with the drive unit 5. The braking unit 6 is controlled by the vehicle control device 10 during driving assistance.

The vehicle 1 includes a steering unit 7 for controlling the traveling direction. The steering unit 7 is, for example, a power steering system that provides a steering angle to steered wheels in response to a steering wheel operation. When the vehicle 1 is an electrified vehicle, the steering unit 7 may be integrated with the drive unit 5 that variably controls driving forces of right and left drive wheels. During driving assistance, the steering unit 7 is controlled by the vehicle control device 10 to adjust the steering angle.

The vehicle control device 10 includes a control unit 11 that executes control related to the traveling of the vehicle 1. The control unit 11 centrally controls the traveling of the vehicle 1, driving assistance, navigation, communication via a network W, etc. based on detection values detected by the detection unit 2. The control unit 11 is at least one hardware processor such as a central processing unit (CPU). The control unit 11 may be implemented by hardware (including circuitry) such as a large scale integration (LSI), an application specific integrated circuit (ASIC), a field-programmable gate array (FPGA), or a graphics processing unit (GPU), or may be implemented by software and hardware in cooperation.

The vehicle control device 10 includes a storage unit 12 that stores data and programs. The storage unit 12 is a non-transitory storage medium such as a hard disk drive (HDD) or a solid state disk (SSD). The storage unit 12 (storage medium) stores computer programs and data necessary for controlling the vehicle 1. The programs may be prestored in the storage unit 12, or may be stored in an externally connectable storage medium such as a DVD or a CD-ROM and installed in the storage unit 12 by inserting the storage medium into a drive. The control unit 11 controls the drive unit 5, the braking unit 6, and the steering unit 7 based on detection values detected by the detection unit 2, and executes autonomous driving control for causing the vehicle 1 to travel autonomously.

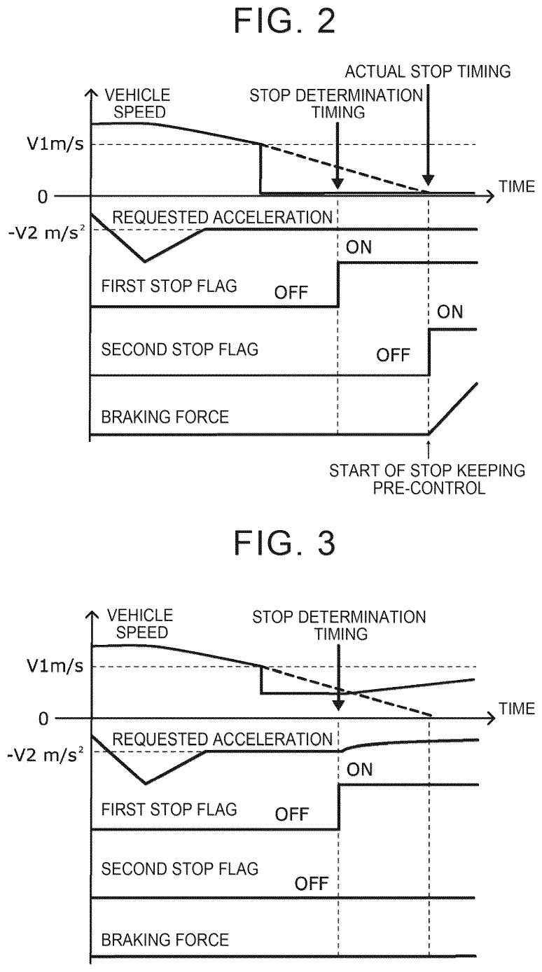

As shown in FIG. 2, the control unit 11 is configured to execute stop control on the vehicle 1 traveling by autonomous driving. The control unit 11 acquires a detection value from the detection unit 2. The control unit 11 calculates a vehicle speed (V m/s) of the vehicle 1 based on, for example, a detection value from the acceleration sensor 2E. When the vehicle 1 is decelerating, the control unit 11 executes stop control for stopping the vehicle 1 from an extremely low speed range of the vehicle speed before the stop. The extremely low speed range is, for example, several tens of meters per second or lower. In deceleration control for decelerating the vehicle 1, the control unit 11 acquires a requested acceleration for reducing the vehicle speed, and controls the braking force of the braking unit 6 such that the vehicle speed reaches a speed based on the requested acceleration. The requested acceleration is, for example, a command set in a travel plan based on autonomous driving.

The control unit 11 compares the vehicle speed with a threshold value, and determines whether the vehicle speed is equal to or lower than the threshold value. The threshold value is set based on, for example, the detection limit value of the acceleration sensor 2E. The threshold value is, for example, a value of 50 cm/s (V1 m/s) or lower. As shown in the figure, a vehicle speed equal to or lower than the threshold value is not detected. When the vehicle is decelerating, the control unit 11 calculates a stop determination timing for the vehicle to stop after the vehicle speed reaches the threshold value or lower based on a detection value related to the traveling of the vehicle. For example, the control unit 11 starts counting a timer from the timing at which the vehicle speed reaches the threshold value, and sets the stop determination timing after an elapse of a predetermined period.

When setting the stop determination timing, the control unit 11 may calculate a second timing at which the vehicle 1 will stop in the future from a first timing at which the vehicle speed reaches the threshold value, and set the stop determination timing to the calculated second timing. The control unit 11 may calculate a future vehicle speed based on a detection value of the acceleration immediately before the first timing and an image captured by the camera 2A, and set the stop determination timing to a timing at which the vehicle speed approaches zero.

At the stop determination timing, the control unit 11 sets a first stop flag that is a control variable for controlling the braking unit 6 from an OFF state that is the normal state to an ON state. The control unit 11 determines whether to execute stop keeping pre-control for keeping the vehicle in a stopped state based not only on the state of the first stop flag but also on the state of a second stop flag that is a control variable for controlling the braking unit 6. The second stop flag is, for example, a control variable for determining whether there is an intention to stop the vehicle 1. The control unit 11 determines whether the vehicle 1 has stop intention based on a detection value.

When the control unit 11 determines, based on the detection value, that a predetermined state related to the stop intention is present, the control unit 11 sets the second stop flag to an ON state. The control unit 11 is configured to recognize the environment and objects around the vehicle 1 based on images captured by the camera 2A, for example, by executing machine learning such as deep learning in advance using image data as training data.

The control unit 11 may recognize the state around the vehicle 1 based on an image captured by the camera 2A, and determine that the vehicle 1 has stop intention when there is a predetermined state in which the vehicle 1 needs to stop. The predetermined state includes a state in which there is a high probability of a future stop of the vehicle 1, such as a stop based on a traffic signal requesting a stop, a stop based on approach of traffic participants such as other vehicles or pedestrians, a stop based on traffic conditions, a stop based on parking, and a stop following a preceding vehicle.

When a stop command is provided from a device related to autonomous driving in a travel plan of a navigation device (not shown), etc., the control unit 11 may determine that the predetermined state is present and that the vehicle 1 has stop intention. When another safety system such as an automatic braking system is executed and a stop command is provided, the control unit 11 may determine that the predetermined state is present and that the vehicle 1 has stop intention. When another safety system is executed and the target vehicle speed is set to 0 km/h or to 0 km/h or lower, the control unit 11 may determine that the vehicle 1 has stop intention. When another safety system is executed and the requested acceleration is set to a large negative value after the vehicle 1 has stopped, the control unit 11 may determine that the vehicle 1 has stop intention.

When the control unit 11 determines that the vehicle 1 has stop intention, the control unit 11 sets the second stop flag from an OFF state that is the normal state to an ON state. When the first stop flag is in the ON state and the second stop flag is in the ON state, the control unit 11 executes the stop keeping pre-control to keep the vehicle 1 in the stopped state. When executing the stop keeping pre-control, the control unit 11 controls the braking device of the braking unit 6 at the stop determination timing to keep the vehicle in the stopped state.

As shown in FIG. 3, when the control unit 11 determines, based on the detection value, that the predetermined state is not present, the control unit 11 keeps the second stop flag in the OFF state. When the control unit 11 determines, based on the detection value, that the predetermined state will disappear in the future as in a situation where the vehicle 1 is making a U-turn or a situation where a preceding vehicle starts moving from a stopped state, the control unit 11 keeps the second stop flag in the OFF state.

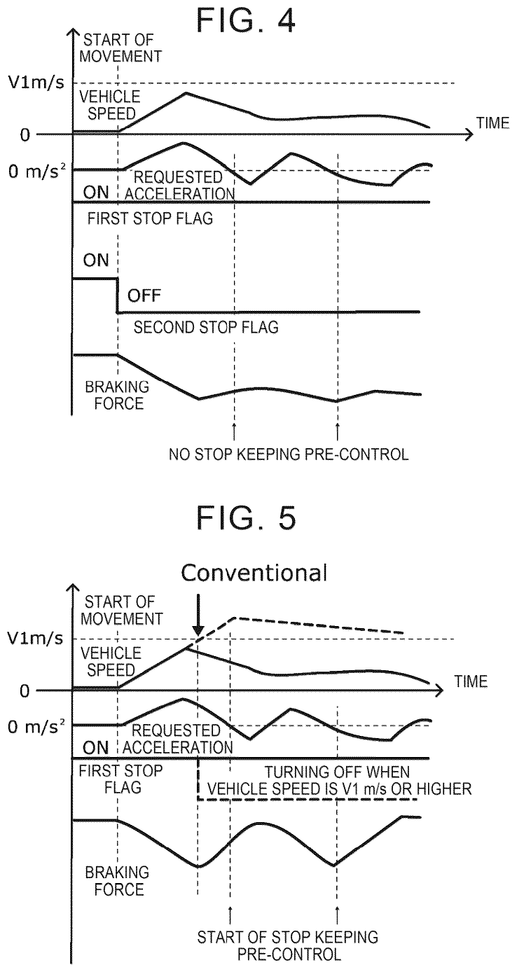

As shown in FIG. 4, when the control unit 11 determines that the predetermined state that is currently present will disappear in the future, the control unit 11 may set, again to the OFF state, the second stop flag that has been set to the ON state. As shown in the figure, the control unit 11 monitors the vehicle speed during deceleration in autonomous driving. When the vehicle speed reaches the threshold value or lower, the control unit 11 calculates the stop determination timing, and sets the first stop flag to the ON state at the stop determination timing. When the control unit 11 recognizes the state around the vehicle 1 based on an image captured by the camera 2A and determines that the predetermined state in which the vehicle 1 needs to stop is not present, the control unit 11 sets the second stop flag from the ON state to the OFF state.

When the first stop flag is in the ON state and the second stop flag is in the OFF state, the control unit 11 does not execute the stop keeping pre-control. In the above process, when the vehicle 1 is following a preceding vehicle within the extremely low speed range, the control unit 11 does not execute the stop keeping pre-control. Therefore, the vehicle 1 continues traveling at the extremely low speed without causing a braking shock.

FIG. 5 shows a related-art method in which the stop keeping pre-control is executed using only the first stop flag without using the second stop flag. When the stop keeping pre-control is executed using only the first stop flag and the vehicle speed is equal to or lower than the threshold value, the first stop flag is kept in the ON state. Therefore, the vehicle repeatedly undergoes the stop keeping pre-control, and a braking shock may occur each time. The vehicle control device 10 executes the process based on the first stop flag and the second stop flag, and can therefore suppress the occurrence of an unnecessary braking shock even when the vehicle speed is equal to or lower than the threshold value.

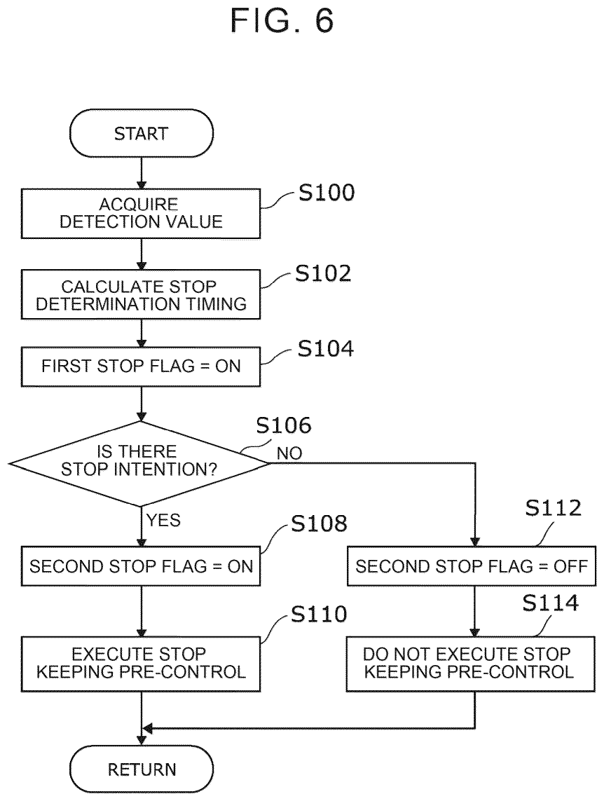

FIG. 6 shows the flow of a process in a vehicle control method to be executed by the vehicle control device 10. The vehicle control method is executed based on a computer program installed in a computer mounted on the vehicle control device 10. The computer program causes the control unit 11 (processor) of the computer mounted on the vehicle control device 10 to execute the following process. The control unit 11 acquires a detection value related to the traveling of the vehicle that is detected by the detection unit 2 (S100). When the vehicle is decelerating, the control unit 11 calculates the stop determination timing based on the detection value (S102). The control unit 11 sets the first stop flag from the OFF state to the ON state at the stop determination timing (S104).

The control unit 11 determines whether the vehicle has stop intention based on the detection value (S106). When the control unit 11 determines that the vehicle 1 has stop intention, the control unit 11 sets the second stop flag from the OFF state to the ON state (S108). When the first stop flag is in the ON state and the second stop flag is in the ON state, the control unit 11 executes the stop keeping pre-control for keeping the vehicle in a stopped state (S110). When the control unit 11 determines in S106 that the vehicle 1 does not have stop intention, the control unit 11 keeps the second stop flag in the OFF state (S112). When the first stop flag is in the ON state and the second stop flag is in the OFF state, the control unit 11 does not execute the stop keeping pre-control (S114).

As described above, the vehicle control device 10 can reduce the braking shock caused by the braking force that is not requested by the system when the vehicle 1 is traveling at an extremely low speed during the autonomous driving. The vehicle control device 10 determines whether to execute the stop keeping pre-control based not only on the state of the first stop flag but also on the state of the second stop flag. Therefore, it is possible to suppress the occurrence of an unnecessary braking shock when the vehicle 1 is traveling at an extremely low speed during the autonomous driving. The vehicle control device 10 can suppress the occurrence of an unnecessary braking shock when the vehicle 1 follows a preceding vehicle at an extremely low speed during the autonomous driving.

In the above embodiment, the computer program to be executed in each component of the vehicle control device 10 may be provided by being recorded on a computer-readable portable recording medium such as a semiconductor memory, a magnetic recording medium, or an optical recording medium. The computer program may be provided as a program product.

What is claimed is:

1. A vehicle control device comprising a control unit configured to execute stop control on a vehicle traveling by autonomous driving, wherein
the control unit is configured to:
when the vehicle is decelerating, calculate a stop determination timing for the vehicle to stop based on a detection value related to traveling of the vehicle, and set a first stop flag from an OFF state to an ON state at the stop determination timing;
when determination is made that the vehicle has stop intention based on the detection value, set a second stop flag from an OFF state to an ON state;
when the first stop flag is in the ON state and the second stop flag is in the ON state, execute stop keeping pre-control for keeping the vehicle in a stopped state; and
when the first stop flag is in the ON state and the second stop flag is in the OFF state, not execute the stop keeping pre-control.

2. The vehicle control device according to claim 1, wherein the control unit is configured to set the second stop flag to the ON state when determination is made that a predetermined state related to the stop intention is present based on the detection value.

3. The vehicle control device according to claim 2, wherein the control unit is configured to keep the second stop flag in the OFF state when determination is made that the predetermined state is not present based on the detection value.

4. The vehicle control device according to claim 1, wherein the control unit is configured to, when executing the stop keeping pre-control, control a braking device for deceleration of the vehicle at the stop determination timing to bring the vehicle into the stopped state.

5. A non-transitory storage medium storing a computer program to be installed on a computer mounted on a vehicle control device configured to execute stop control on a vehicle traveling by autonomous driving, the computer program causing the computer to execute a process including:
when the vehicle is decelerating, calculating a stop determination timing for the vehicle to stop based on a detection value related to traveling of the vehicle, and setting a first stop flag from an OFF state to an ON state at the stop determination timing;
when determination is made that the vehicle has stop intention based on the detection value, setting a second stop flag from an OFF state to an ON state;
when the first stop flag is in the ON state and the second stop flag is in the ON state, executing stop keeping pre-control for keeping the vehicle in a stopped state; and
when the first stop flag is in the ON state and the second stop flag is in the OFF state, not executing the stop keeping pre-control.
